(19) United States
(12) Patent Application Publication
(10) Pub. No.: US 2013/0192559 A1
(43) Pub. Date: Aug. 1, 2013

(54) CONNECTING ROD AND METHOD OF MANUFACTURE

(71) Applicant: Russell A. Chernenkoff, Livonia, MI (US)

(72) Inventor: Russell A. Chernenkoff, Livonia, MI (US)

(21) Appl. No.: 13/754,248

(22) Filed: Jan. 30, 2013

Related U.S. Application Data
(60) Provisional application No. 61/592,302, filed on Jan. 30, 2012.

(51) Int. Cl. F16C 7/02

(52) U.S. Cl. CPC F16C 7/023
USPC 123/197.3; 419/38; 75/228

(57) ABSTRACT

A method of forming a connecting rod, the method including the steps of: forming the connecting rod via a powder forging process; forming an integral wear resistant surface inside a bore of the connecting rod via an inductive heating process after completion of the powder forging process.

### CROSS REFERENCE TO RELATED APPLICATIONS

This application claims the benefit of U.S. Provisional Application No. 61/592,302, filed Jan. 30, 2012, the contents of which are incorporated herein by reference thereto.

### BACKGROUND

Various embodiments of the present invention relate to a connecting rod and more particularly, a method of making a connecting rod.

The connecting rod manufacturing process involves pressure molding metal particles in a closed mold under significant pressure to produce a green compact form of the rod. Next, the green compact is heated in a furnace sufficiently to form a sintered preform in which metal particles are bonded. Next, the sintered preform is hot forged to final rod shape which increases the rod's density and strength.

Still further, the automobile industry continues to challenge connecting rod manufacturers to improve these articles. In many piston powered units, such as compressors and internal combustion engines, full floating piston or wrist pins are used to operatively connect connecting rods with pistons for operating in an associated cylinder. In the past these pins where fit into a pin bearing or bushing at the small end of the connecting rod through which the pin extends or the inner surface of the opening was provided with a coating. However, each of these processes adds to the cost of manufacturing the connecting rod.

Accordingly, it is desirable to provide a connecting rod and method of making wherein the aforementioned coating or busing are eliminated from the small end of the connecting rod without sacrificing performance.

### SUMMARY OF THE INVENTION

In one embodiment, a method of forming a connecting rod is provided, the method including the steps of: forming the connecting rod via a powder forging process; forming an integral wear resistant surface inside a bore of the connecting rod via an inductive heating process after completion of the powder forging process; and wherein the bore of the connecting rod does not have a bushing inserted therein.

In another embodiment, a connecting rod for an internal combustion engine is provided, the connecting rod having: a first end portion and a second end portion and an elongated mid-portion extending therebetween, wherein the first end portion is smaller than the second end portion and a bore extends through the first end portion; an integrally formed wear resistant surface located inside the bore, the integrally formed wear resistant surface having a greater hardness than a remainder of the connecting rod; and wherein the bore of the connecting rod does not have a bushing inserted therein.

In still another embodiment, an assembly for an internal combustion engine is provided, the assembly having: a connecting rod, the connecting rod comprising: a first end portion and a second end portion and an elongated mid-portion extending there between, wherein the first end portion is smaller than the second end portion and a bore extends through the first end portion; an integrally formed wear resistant surface located inside the bore, the integrally formed wear resistant surface having a greater hardness than a remainder of the connecting rod; and wherein the bore of the connecting rod does not have a bushing inserted therein; and a piston secured to the connecting rod via a piston pin that is rotatably received within the bore.

In yet another embodiment, a method of forming a connecting rod is provided, the method including the steps of: forming the connecting rod via a powder forging process; forming an integral wear resistant surface inside a bore of the connecting rod via an inductive heating process after completion of the powder forging process.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a view of a connecting rod formed in accordance with an embodiment of the present invention secured to a piston;

FIG. 1A is a view of a connecting rod formed in accordance with an alternative embodiment of the present invention secured to a piston

FIG. 2 are views illustrating a connecting rod formed in accordance with an embodiment of the present invention;

FIG. 2A are views illustrating a connecting rod formed in accordance with an alternative embodiment of the present invention;

FIG. 3 is a flowchart illustrating the manufacturing process in accordance with an embodiment of the present invention; and

FIG. 4 schematically illustrates a part having an integral wear resistant surface formed therewith according to one non-limiting exemplary embodiment of the present invention.

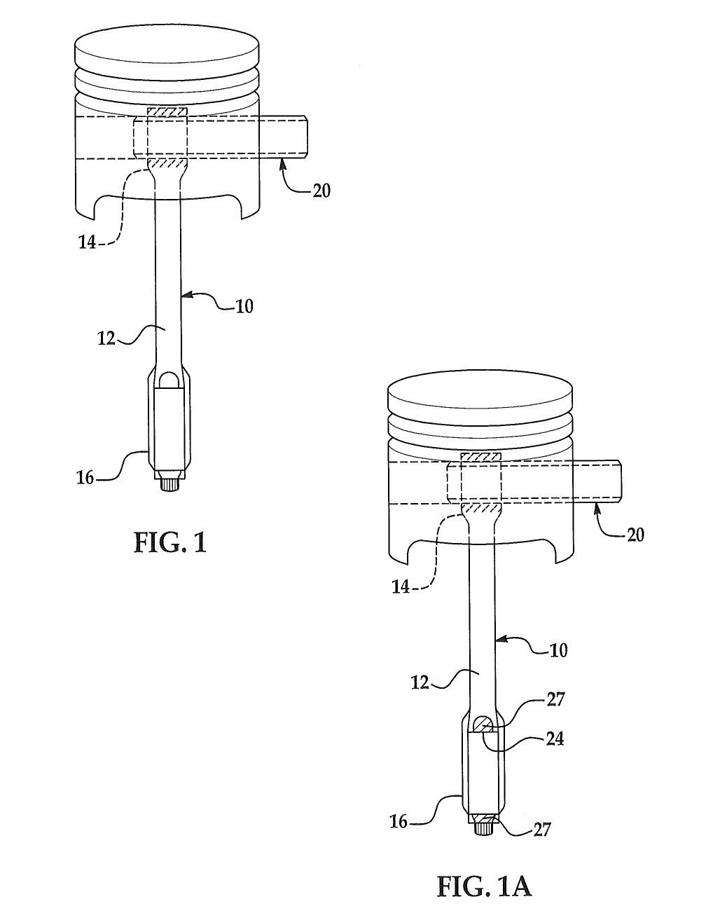

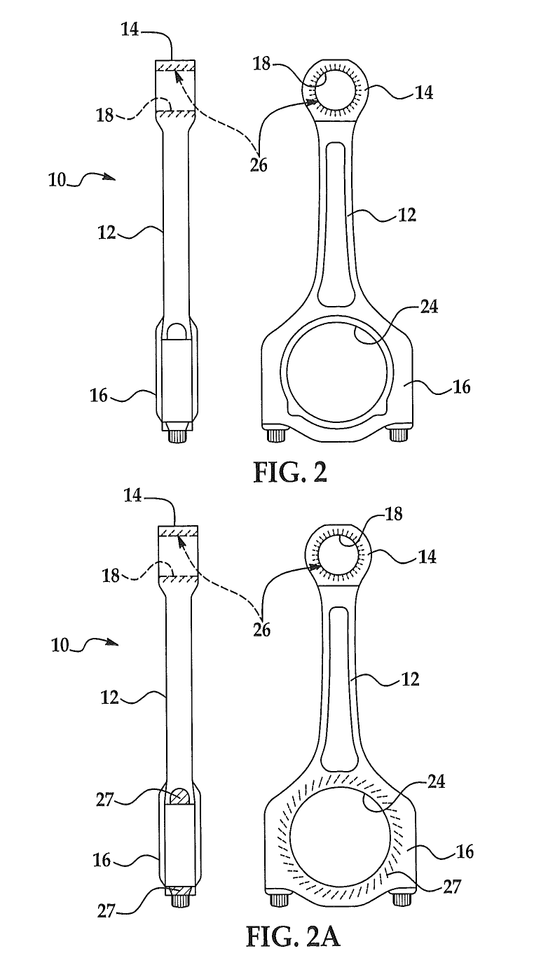

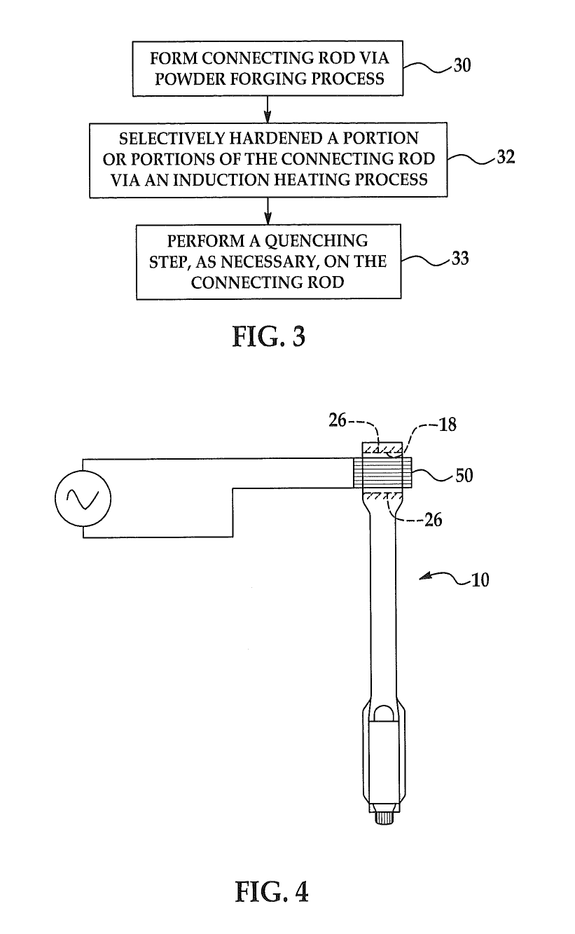

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Reference is made to U.S. Pat. No. 6,579,492, the contents of which are incorporated herein by reference thereto. Referring now to the FIGS., a connecting rod 10 manufactured in accordance with the teachings of the present application is illustrated. Rod 10 has an elongated configuration including a mid-portion 12, a small end portion 14 and a large end portion 16. A bore 18 is formed through small end portion 14 adapted to receive a wrist or piston pin 20 of a piston 22 as is well known in the engine art. An aperture 24 is formed large end 16 and is adapted to receive a journal of a crankshaft (not shown) as is also well known in the engine art.

In accordance with an embodiment of the present invention, the connecting rod 10 is formed via a first step 30 comprising a powder forging process. Thereafter, the connecting rod is further formed via a second step 32 wherein a portion 26 of the connecting rod proximate to the bore of the small end portion 14 is subjected to a further processing step namely an inducting heating step 32 wherein the portion 26, via the subsequent heating treating step in a localized area, provides a wear resistant surface in bore 18 for interaction with the piston pin 20. This wear resistant surface negates the need for a separately formed bushing as described in U.S. Pat. No. 6,579,492. Still further, the wear resistance surface also negates the need for a separately applied bushing or coating in lieu of or in addition to the bushing.

Still further and in one non-limiting exemplary embodiment, the inductive heating step 32 will be followed by or include a quenching step 33, wherein the applied heat to the part via the inductive heating step is removed rapidly while minimizing any stresses that may occur during the quenching process.

In an alternative embodiment, a portion 27 proximate to the aperture 24 of the large end 16 is also subjected to the further processing step namely, the aforementioned inducting heating step wherein the portion 27, via the subsequent heating treating step in a localized area, provides a wear resistant surface in aperture 24 for interaction with the journal of the crankshaft negating any need for a separately applied bearing or coating in lieu of or in addition to the bearing. In yet another alternative embodiment, only portion 27 proximate to the aperture 24 of the large end 16 is subjected to the further processing step namely, the aforementioned inducting heating step and no inducting heating is applied to bore 18 or portion 26. Thus, either bore 18 and aperture 24 may be exclusively subjected to heating treating in a localized area to provide a wear resistant surface or both bore 18 and aperture 24 may be subjected to the heating treating in the localized area to provide the wear resistant surface.

For example and in one non-limiting exemplary embodiment, and during the first step, a green compact is made in the form of the rod by molding powder metal particles in a closed mold under great pressure, typically about 80,000 psi. Of course, the required pressures may vary and be greater or less than the aforementioned value. This pressure molding causes the particles to mechanically interlock and form a stable, relatively weak part but strong enough for handling. Next, the green compact is heated in a furnace at temperatures higher than 2000 degrees Fahrenheit for a period of time sufficient to cause the metal particles to bond. Again and as applications may require, the temperature may also vary. After sintering, the preform has the same configuration as the green compact but is much stronger.

The preform then is hot forged to achieve the shape and increase density and strength as required for a connecting rod. Typically, it is hot forged in a press at a pressure of about 60,000 psi and at a temperature of higher than 1800 degrees Fahrenheit once again, the temperatures and pressures may vary to be greater or less than those provided above.

After the first step, the portion 26 and/or portion 27 of the connecting rod is subjected to induction heating wherein the portion 26 and/or portion 27 is further hardened via the induction heating step and thus a wear resistant surface is provided at the interface of the bore 18 and piston pin 20 as well as aperture 24. In other words, the surface of the bore 18 and/or aperture 24 is further hardened via the induction heating step to provide the wear resistant surface, which is harder than other portions of the connecting rod that are not treated with the inductive heating step. It is also understood that other heating steps may be applied to provide the desired wear resistant surface. In one non-limiting exemplary embodiment, the integral wear resistant surface has a thickness in the range of 0.5 to 2.0 mm extending from the bore 18 and/or aperture 24. Still further, the hardness of heat treated area in one non-limiting embodiment is 55 to 65 HRC according to a Rockwell Hardness Scale or any other equivalent scale. Of course, thicknesses and/or hardnesses greater or less than the aforementioned values are considered to be with the scope of exemplary embodiments of the present invention.

In one non-limiting exemplary embodiment, the temperatures used during the above mentioned inductive heating step are in the range of 600-1200° C. One exemplary range is 850-950° C. Of course, these ranges are provided as examples the required temperatures may vary and may be greater or less than the aforementioned values or ranges.

Still further and in one non-limiting exemplary embodiment, the inductive heating step 32 will be followed by or include a quenching step 33, wherein the applied heat to the part via the inductive heating step is removed rapidly while minimizing any stresses that may occur during the quenching process.

FIG. 4 schematically illustrates part 10 having an integral wear resistant surface formed therewith via one non-limiting inductive heating process wherein a coil 50 or a portion of a coil 50 is inserted into bore 18 and/or aperture 24 of the part 10 after completion of the powder forging process and the part 10 is heated to high temperatures through induced currents via the concentrated magnetic fields created by the coil 50. In one non-limiting embodiment and as necessary, the part may then be quenched via a component next to or integrally associated with coil 50 or alternatively the part itself may be repositioned to another component configured to perform the quenching process after the inductive heating step. Moreover and in yet another non-limiting alternative embodiment, the aforementioned inductive heating steps and quenching may be repeated in order to provide the desired wear resistant surface. Of course, single step processes are also considered to be within the scope of exemplary embodiments of the present invention.

The metal powder may vary in one implementation the base metal powder is a ferrous powder. The sintered preform may be made by an admixed or prealloyed powder. The ferrous powder typically includes other ingredients such as nickel, molybdenum, copper, carbon and the like. The base ferrous iron is admixed with copper, graphite, manganese, sulfur and a lubricant. Of course, other combinations are also considered to be within the scope of exemplary embodiments of the present invention.

For example, prealloyed manganese, sulfur, ferrous based powder can be used for producing the forged article. The prealloyed powder is mixed with copper and carbon to produce a mix used for connecting rod manufacturing.

In one non-limiting embodiment, the composition of the connecting rod comprises 1.50 to 3.50% Cu and 0.45 to 0.90 C each being referred to as weight percent of the rod. Of course, other ranges of Copper and Carbon greater or less than the aforementioned values are considered to be within the scope of exemplary embodiments of the present invention.

It is, of course, understood that this invention may be used to forge articles other than connecting rods. Other automotive uses include piston rings and valve seats for internal combustion engines. Other parts include clutch races, differential gears and similar parts.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of forming a connecting rod, comprising:
forming the connecting rod via a powder forging process;
forming an integral wear resistant surface inside a bore of the connecting rod via an inductive heating process after completion of the powder forging process.

2. The method as in claim 1, wherein the integral wear resistant surface has a thickness in the range of 0.5 to 2.0 mm; and
wherein the bore of the connecting rod does not have a bushing inserted therein.

3. The method as in claim 2, wherein the integral wear resistant surface has a hardness in the range of 55 to 65 HRC.

4. The method as in claim 1, wherein the integral wear resistant surface has a hardness in the range of 55 to 65 HRC; and
wherein the bore of the connecting rod does not have a bearing inserted therein.

5. A connecting rod formed by the method of claim 1.

6. The connecting rod as in claim 5, wherein the integral wear resistant surface has a thickness in the range of 0.5 to 2.0 mm and wherein the integral wear resistant surface has a hardness in the range of 55 to 65 HRC.

7. The connecting rod as in claim 6, wherein the composition of the connecting rod comprises 1.50 to 3.50% Cu and 0.45 to 0.90 C each being referred to as weight percent of the connecting rod.

8. A connecting rod for an internal combustion engine, comprising:
a first end portion and a second end portion and an elongated mid-portion extending therebetween, wherein the first end portion is smaller than the second end portion and a bore extends through the first end portion;
an integrally formed wear resistant surface located inside the bore, the integrally formed wear resistant surface having a greater hardness than a remainder of the connecting rod; and
wherein the bore of the connecting rod does not have a bushing inserted therein.

9. The connecting rod as in claim 8, wherein the integrally formed wear resistant surface has a thickness in the range of 0.5 to 2.0 mm.

10. The connecting rod as in claim 8, wherein the integrally formed wear resistant surface is formed via an inductive heating process after the connecting rod has been first formed via powder forging process.

11. The connecting rod as in claim 10, wherein the integral wear resistant surface has a hardness in the range of 55 to 65 HRC and wherein the integrally formed wear resistant surface has a thickness in the range of 0.5 to 2.0 mm.

12. The connecting rod as in claim 11, wherein the composition of the connecting rod comprises 1.50 to 3.50% Cu and 0.45 to 0.90 C each being referred to as weight percent of the connecting rod and wherein the second end portion also has a bore extending therethrough, wherein the bore of the second end portion does not have a bearing inserted therein and the bore of the second end portion has an integrally formed wear resistant surface formed via an inductive heating process after the connecting rod has been first formed via powder forging process.

13. The connecting rod as in claim 8, wherein the integral wear resistant surface has a hardness in the range of 55 to 65 HRC.

14. An assembly for an internal combustion engine, comprising:
a connecting rod, the connecting rod comprising: a first end portion and a second end portion and an elongated mid-portion extending therebetween, wherein the first end portion is smaller than the second end portion and a bore extends through the first end portion;
an integrally formed wear resistant surface located inside the bore, the integrally formed wear resistant surface having a greater hardness than a remainder of the connecting rod; and
wherein the bore of the connecting rod does not have a bushing inserted therein; and
a piston secured to the connecting rod via a piston pin that is rotatably received within the bore.

15. The assembly as in claim 14, wherein the integrally formed wear resistant surface has a thickness in the range of 0.5 to 2.0 mm.

16. The assembly as in claim 15, wherein the integral wear resistant surface has a hardness in the range of 55 to 65 HRC.

17. The assembly as in claim 14, wherein the integral wear resistant surface has a hardness in the range of 55 to 65 HRC.

18. The assembly as in claim 14, wherein the integrally formed wear resistant surface is formed via an inductive heating process after the connecting rod has been first formed via powder forging process.

19. The assembly as in claim 18, wherein the integrally formed wear resistant surface has a thickness in the range of 0.5 to 2.0 mm and wherein the integral wear resistant surface has a hardness in the range of 55 to 65 HRC.

20. The connecting rod as in claim 19, wherein the composition of the connecting rod comprises 1.50 to 3.50% Cu and 0.45 to 0.90 C each being referred to as weight percent of the connecting rod.
